(19) United States
(12) Patent Application Publication
(10) Pub. No.: US 2005/0067399 A1
(43) Pub. Date: Mar. 31, 2005

(54) Safety device of a coffee pot

(76) Inventors: Chen-Lung Huang, Tainan City (TW); Chuan Pan Huang, Tainan City (TW)

Correspondence Address: HUANG CHEN-LUNG, NO. 17, HSIN-JEN Rd., P.O. Box 2-10, TAINAN CITY, TW

(21) Appl. No.: 10/679,020

(22) Filed: Sep. 30, 2003

(51) Int. Cl. F27D 11/00

(52) U.S. Cl. 219/441

(57) ABSTRACT

A safety device of a coffee pot includes a pot body provided with a water tank and a handle, an electric heater installed under the water tank of the pot body and a probe unit provided on the electric heater in the water tank for detecting the water level in the water tank. The probe has a function of disconnecting electric source automatically or disabling the electric heater to be electrified when water in the water tank is insufficient, ensuring safety in using the coffee pot.

### FIELD OF THE INVENTION

This invention relates to a safety device of a coffee pot, particularly to one safe in using and having high heat efficiency.

### BACKGROUND OF THE INVENTION

A conventional electric coffee pot, as shown in FIG. 1, includes a pot body 1, a water tank 14, an electric heater 10 and plural electric heating tubes 12 combined together. The electric heater 10 provided under the water tank 14 is a metal plate 11 made of an alloy of zinc with aluminum compressed in shape. The electric heating tubes 12 or mica sheet-shaped electric heating filaments are wrapped inside the metal plate 11 when the metal plate 11 is compressed in shape. Thus, when the electric heating tubes 12 or the mica sheet-shaped electric heating filaments are electrified, they will produce high heat which is then transmitted to the metal plate 11 to heat the water in the water tank 14 of the pot body 1 for boiling coffee therein.

However, the electric source of the electric heating tubes 12 or the mica sheet-shaped electric heating filaments of a conventional electric coffee pot is connected and disconnected by a set of twin metal sheets. When the electric heating tubes 12 or the mica sheet-shaped electric heating filaments are electrified to produce high heat, the twin metal sheets will become curved, disconnecting the electric source. Therefore, when there is no water in the water tank of the conventional coffee pot, the twin metal sheets will become curved to disconnect the electric source immediately, but during this period, the temperature of the water tank of the coffee pot would have become very high, likely to cause danger to a user.

### SUMMARY OF THE INVENTION

The objective of the invention is to offer a safety device of a coffee pot, having high heat efficiency, able to precisely control the water level in the water tank of a coffee pot and ensuring safety in operating and using.

The characteristics of the invention are as follows.

1. The safety device of a coffee pot includes a pot body provided with a water tank and an electric heater installed in the water tank. The electric heater is electrified to produce high heat for boiling coffee.

2. The safety device of a coffee pot is provided with a probe unit on the electric heater in the water tank. The probe unit is able to precisely detect the water level in the water tank to make sure that the coffee pot cannot be kept electrified in case of no water left in the water tnak, avoiding idle burning and enhancing safety in using.

3. The probe unit of the safety device of a coffee pot is provided with a metal probe wrapped up by an insulation material so that the metal probe can be fixed at a proper location on the electric heater.

### BRIEF DESCRIPTION OF DRAWINGS

This invention will be better understood by referring to the accompanying drawings, wherein:

FIG. 1 is a partial cross-sectional view of a conventional coffee pot:

FIG. 2 is a cross-sectional view of a coffee pot in the present invention:

FIG. 3 is a cross-sectional view of a first preferred embodiment of the probe unit of the safety device of a coffee pot in the present invention:

FIG. 4 is a cross-sectional view of a second preferred embodiment of the probe unit of the safety device of a coffee pot in the present invention:

FIG. 5 is a cross-sectional view of the first preferred embodiment of a coffee pot in the present invention:

FIG. 6 is a cross-sectional view of the second preferred embodiment of a coffee pot in the present invention: and

FIG. 7 is an evolved view of the control circuit of the safety device of a coffee pot in the present invention.

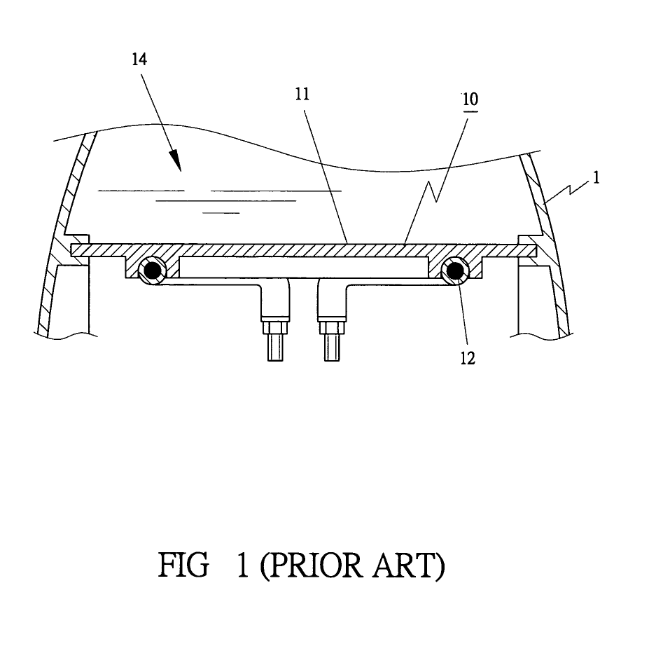

### DETAILED DESCRIPTION OF THE INVENTION

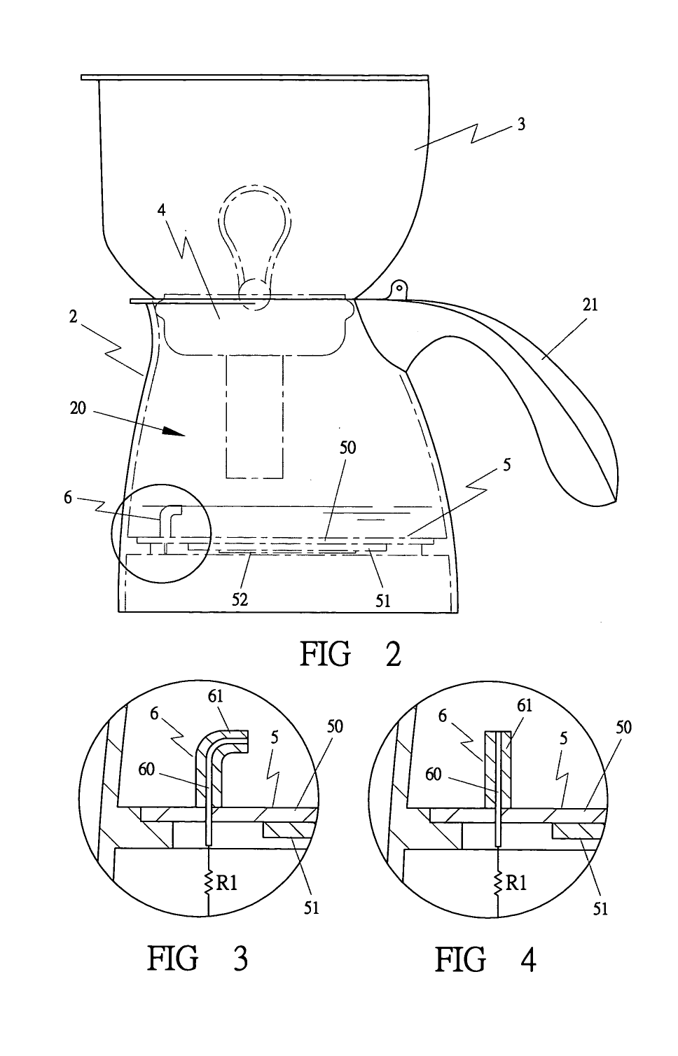

A first preferred embodiment of a safety device of a coffee pot in the present invention, as shown in FIG. 2, includes a pot body 2, a coffee cup 3, a siphon device 4, an electric heater 5 and a probe unit 6 as main components combined together.

The pot body 2 is provided with a water tank 20 for storing water to be heated and a handle 21 for lifting up the coffee pot to pour coffee out or facilitating to clean the coffee pot.

The coffee cup 3 is fitted on the pot body 2 for storing ground coffee powder therein.

The siphon device 4 is positioning at the upper portion of the pot body 2.

The electric heat 5 installed under the water tank 20 of the pot body 2 is provided with a heat conducting metal plate 50, which is completely fixed by the pot body 2 and has a function of preventing water permeation. An insulating plate 51 is provided under the heat conducting metal plate 50, and an electric heating membrane 52 is thermal-plated under the insulating plate 51 to form face contact between them so as to produce highly heating effect.

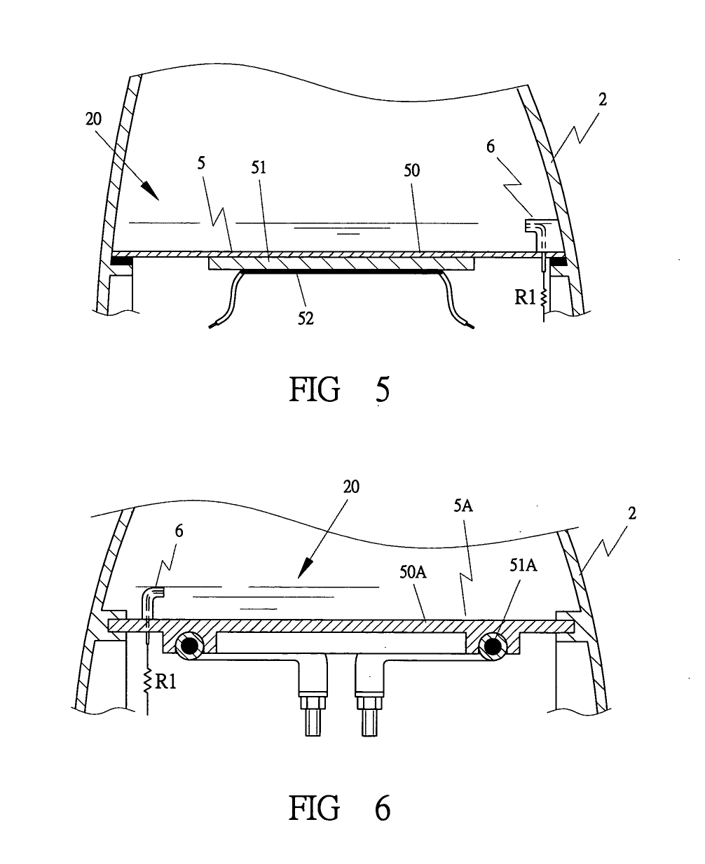

The probe unit 6, as shown in FIGS. 3, 4 and 5, is provided at a proper position on the electric heater 5, having a metal probe 60 wrapped up by an insulating material 61.

A second preferred embodiment of a safety device of a coffee pot in the present invention, as shown in FIG. 6, includes a pot body 2, a coffee storing cup 3, a siphon device 4, an electric heater 5A and a probe unit 6 combined together.

The pot body 2 is provided with a water tank 20 for storing water to be heated and a handle.

The electric heater 5A installed under the water tank 2 is a metal plate 50A made of an alloy of zinc with aluminum compressed in shape. Plural electric heating tubes 51A or mica sheet-shaped electric heating filaments are wrapped in the metal plate 50A when the metal plate 50A is compressed in shape. Thus, the electric heating tubes 51A or the mica sheet-shaped electric heating filaments are electrified to produce high heat which is then transmitted to the metal plate 50A to heat the water in the water tank 20 for boiling coffee therein.

The probe unit 6 is provided at a proper location on the electric heater 5A in the water tank 20, as shown in FIGS. 3, 4 and 6. The probe unit 6 is provided with a metal probe 60 wrapped up by an insulating material 61.

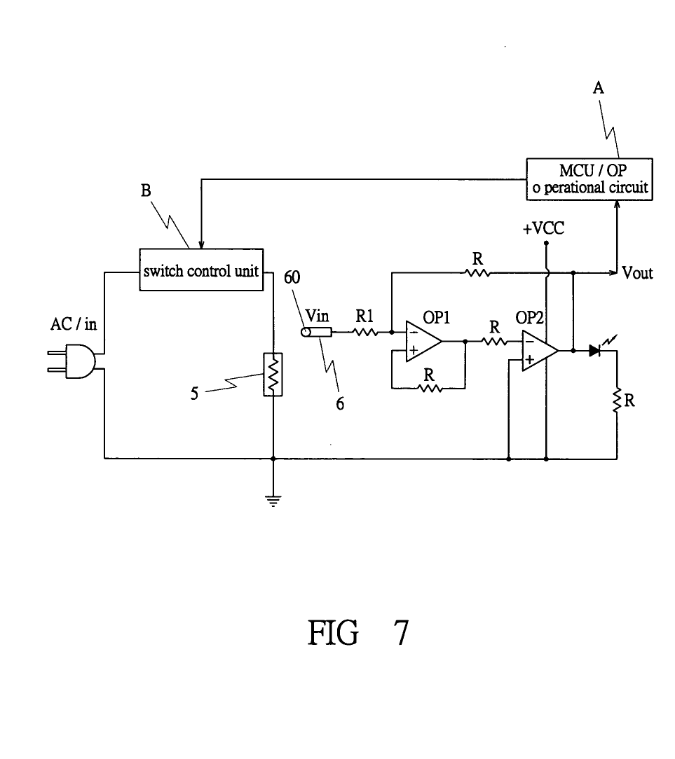

Thus, when the water level in the water tank 20 of the coffee pot is higher than the probe unit 6, the metal probe 60 of the probe unit 6 will produce a signal of micro voltage difference for a resistance R1, as shown in FIG. 7. Then, the signal coming from the resistance R1 actuates two comparison circuits OP1, OP2 to let a single-plate processing unit MCU and an OP operational circuit A operate and control a switch control unit B to connect and disconnect the electric source to turn on and off the electric heater 5, 5A.

On the contrary, if the water level in the water tank 20 of the coffee pot is lower than the probe unit 6, the metal probe 60 does not produce any signal of voltage difference for the resistance R1, and the two comparison circuits OP1, OP2 get no signal from the resistance R1. Therefore, the single-plate processing unit MUC and the OP operational circuit (A) are kept still not functioning with the electric source of the electric heater 5, 5A is disconnected, able to prevent the electric heater of a coffee pot from being electrified continuously when water in the water tank is insufficient, to avoid danger caused by idle burning.

While the preferred embodiments of the invention have been described above, it will be recognized and understood that various modifications may be made therein and the appended claims are intended to cover all such modifications that may fall within the spirit and scope of the invention.

1. A safety device of a coffee pot comprising:
a pot body provided with a water tank and a handle:
a n electric heater installed under said water tank: and
a probe unit provided on said electric heater in said water tank.

2. The safety device of a coffee pot as claimed in claim 1, wherein said probe unit is provided with a metal probe, said metal probe wrapped up by an insulating material.

3. The safety device of a coffee pot comprising a control circuit, said control circuit comprising:
a metal probe, said metal probe able to produce a signal of micro voltage difference for a resistance R1 according to a height of the water level of said water tank:
two comparison circuits OP1, OP2 actuated to operate by said signal coming from said resistance R1, said two comparison circuits OP1, OP2 actuating a single-plate processing unit MCU and an OP operational circuit (A) to operate, said single-plate processing unit MCU and said OP operational circuit (A) controlling a switch control unit to operate, said switch control unit turning on and off the electric source of said electric heater of said coffee pot.
